(19) United States
(12) Patent Application Publication
(10) Pub. No.: US 2011/0118401 A1
(43) Pub. Date: May 19, 2011

(54) POLYPROPYLENE RESIN COMPOSITION FOR COWL TOP COVER OF AUTOMOBILE

(75) Inventors: Jae Hong Kim, Incheon (KR); Yong Bum Lee, Gyeonggi-do (KR); Jong Hyun Kim, Gyeonggi-do (KR)

(73) Assignee: HYUNDAI MOTOR COMPANY, Seoul (KR)

(21) Appl. No.: 12/824,289

(22) Filed: Jun. 28, 2010

(30) Foreign Application Priority Data
Nov. 18, 2009 (KR) 10-2009-0111513

(51) Int. Cl. C08L 53/00; C08K 3/30

(52) U.S. Cl. 524/423; 524/505

(57) ABSTRACT

Provided is a polypropylene resin composition for a cowl top cover of an automobile, which includes: an ethylene-propylene block copolymer containing 3 to 20 wt % of an ethylene monomer; an ethylene-propylene block copolymer containing 30 to 50 wt % of an ethylene monomer; an ethylene-α-olefin copolymer rubber; a magnesium compound; and an inorganic filler. The polypropylene resin composition has excellent rigidity, dimensional stability, and moldability, and thus is suitable for, e.g., a cowl top cover of an automobile.

### CROSS-REFERENCE(S) TO RELATED APPLICATIONS

The present application claims priority of Korean Patent Application No. 10-2009-0111513, filed on Nov. 18, 2009, which is incorporated herein by reference.

### BACKGROUND

1. Field of the Invention

The present invention relates to a polypropylene resin composition for a cowl top cover of an automobile.

2. Description of the Related Art

Being superior in moldability, impact resistance, chemical resistance, specific gravity and cost, polypropylene composite resins have been widely used for manufacturing interior and exterior materials of vehicles. Specifically, they are suitable for parts where excellent dimensional stability and moldability are required, for example, a cowl top cover.

However, even though polypropylene resin compositions developed so far have excellent physical properties such as dimensional stability, moldability, and rigidity, the weight of the parts formed thereof increases and weather resistance decreases.

Accordingly, there is a need for the development of a polypropylene resin composition having excellent physical properties such as moldability, rigidity, weather resistance, and dimensional stability as well as low weight by reducing the amounts of filling materials.

The above information disclosed in this Background section is only for enhancement of understanding of the background of the invention and therefore it may contain information that does not form the prior art that is already known in this country to a person of ordinary skill in the art.

### SUMMARY

The present inventors have conducted extensive researches to solve the aforesaid problems and meet the need of industry. As a result, they have developed a polypropylene resin composition for a cowl top cover of an automobile by adjusting a desired ratio of an inorganic filler to an ethylene-polypropylene block copolymer to reduce the amount of the inorganic filler.

The present invention provides a polypropylene resin composition for a cowl top cover of an automobile having excellent properties.

According to an aspect of the present invention, there is provided a polypropylene resin composition for a cowl top cover of an automobile, the polyethylene resin composition comprising: 30 to 70 wt % of an ethylene-propylene block copolymer comprising 3 to 20 wt % of an ethylene monomer; 5 to 20 wt % of an ethylene-propylene block copolymer comprising 30 to 50 wt % of an ethylene monomer; 5 to 15 wt % of an ethylene-α-olefin copolymer rubber; 1 to 7 wt % of a magnesium compound; and 15 to 30 wt % of an inorganic filler.

The polypropylene resin composition according to the present invention provides superior moldability, rigidity, weather resistance, and fluidity, and has a low weight. In particular, the polypropylene resin composition has excellent dimensional stability, and thus may be suitable for a cowl top cover of an automobile.

### DETAILED DESCRIPTION

An embodiment of the present invention provides a polypropylene resin composition that is suitable for a cowl top cover of an automobile, the polypropylene resin composition includes: an ethylene-propylene block copolymer containing 3 to 20 wt % of an ethylene monomer; an ethylene-propylene block copolymer containing 30 to 50 wt % of an ethylene monomer; an ethylene-α-olefin copolymer rubber; a magnesium compound; and an inorganic filler.

Using the polypropylene resin composition according to the present embodiment, a cowl top cover having better physical properties such as dimensional stability, moldability, rigidity, and weather resistance than conventional parts may be manufactured.

Hereinafter, the present invention will be described in more detail.

The polypropylene resin composition for a cowl top cover of an automobile according to the present embodiment includes: about 30 to 70 wt % of the ethylene-propylene block copolymer containing about 3 to 20 wt % of an ethylene monomer; about 5 to 20 wt % of the ethylene-propylene block copolymer containing about 30 to 50 wt % of an ethylene monomer; about 5 to 15 wt % of the ethylene-α-olefin copolymer rubber; about 1 to 7 wt % of the magnesium compound; and about 15 to 30 wt % of the inorganic filler.

The ethylene-propylene block copolymer containing 3 to 20 wt % of an ethylene monomer is a highly crystalline and highly fluidic propylene composite and is a copolymer of ethylene and propylene. The amount of ethylene may be in the range of 3 to 20 wt %, preferably, 5 to 15 wt %. In addition, the ethylene-propylene block copolymer containing 3 to 20 wt % of an ethylene monomer may have a melt index in the range of 10 to 80 g/10 min, and preferably, 25 to 75 g/10 min at 230° C. In this regard, if the amount of ethylene is less than 3 wt %, impact strength of the polypropylene resin composition may be deteriorated. On the other hand, if the amount of ethylene is greater than 20 wt %, rigidity of the polypropylene resin composition may be deteriorated. In addition, if the melt index of the ethylene-propylene block copolymer containing 3 to 20 wt % of an ethylene monomer is less than 10 g/10 min, fluidity may be deteriorated so that appearance problems such as weld line, sink, flow mark, etc., may be caused after molding. On the other hand, if the melt index of the ethylene-propylene block copolymer containing 3 to 20 wt % of an ethylene monomer is greater than 80 g/10 min, rigidity and impact strength may be deteriorated.

The amount of the ethylene-propylene block copolymer containing 3 to 20 wt % of an ethylene monomer may be in the range of 30 to 70 wt %, preferably 40 to 60 wt %, based on the total weight of the polypropylene resin composition. In this regard, if the amount of the ethylene-propylene block copolymer containing 3 to 20 wt % of an ethylene monomer is less than 30 wt %, fluidity may be deteriorated to cause poor moldability. On the other hand, if the amount of the ethylene-propylene block copolymer containing 3 to 20 wt % of an ethylene monomer is greater than 70 wt %, it is difficult to balance rigidity and impact property.

The ethylene-propylene block copolymer containing 30 to 50 wt % of an ethylene monomer is a low shrinkage polyethylene composite and is a copolymer of ethylene and propylene. The amount of ethylene may be in the range of 30 to 50 wt %, preferably, in the range of 35 to 45 wt %. In addition, the ethylene-propylene block copolymer containing 3 to 50 wt % of an ethylene monomer may have a melt index in the range of 3 to 15 g/10 min, and preferably, 5 to 10 g/10 min at 230° C. In this regard, if the amount of ethylene is less than 30 wt %, dimensional stability of the polypropylene resin composition may be deteriorated. On the other hand, if the amount of ethylene is greater than 50 wt %, rigidity thereof may be deteriorated. In addition, if the melt index of the ethylene-propylene block copolymer containing 3 to 50 wt % of an ethylene monomer is less than 3 g/10 min, fluidity may be deteriorated so that appearance problems such as weld line, sink, flow mark, etc., may be caused after molding. On the other hand, if the melt index of the ethylene-propylene block copolymer containing 3 to 50 wt % of an ethylene monomer is greater than 15 g/10 min, rigidity, impact strength, and dimensional stability may be deteriorated.

The amount of the ethylene-propylene block copolymer containing 3 to 50 wt % of an ethylene monomer may be in the range of 5 to 20 wt %, preferably 8 to 18 wt %, based on the total weight of the polypropylene resin composition. In this regard, if the amount of the ethylene-propylene block copolymer containing 3 to 50 wt % of an ethylene monomer is less than 5 wt %, fluidity may be deteriorated resulting in poor moldability. On the other hand, if the amount of the ethylene-propylene block copolymer containing 3 to 50 wt % of an ethylene monomer is greater than 20 wt %, rigidity may be deteriorated.

The ethylene-α-olefin copolymer rubber is added to improve impact resistance by providing elasticity to the polypropylene resin composition. Generally, as the ethylene-α-olefin copolymer, one selected from the group consisting of ethylene/propylene copolymer (EPR), ethylene/butene-1 copolymer (EBM), ethylene/octene-1 copolymer (EOM), or any combinations thereof may be used. The amount of α-olefin contained in each combination may respectively be 20 to 80 wt % of the EPR, 12 to 25 wt % of EBM, and 15 to 45 wt % of EOM.

The amount of the ethylene-α-olefin copolymer rubber may be in the range of 5 to 15 wt %, preferably 8 to 13 wt %, based on the total weight of the polypropylene resin composition. In this regard, if the amount of ethylene-α-olefin copolymer rubber is greater than 15 wt %, rigidity and moldability of the polypropylene resin composition may be deteriorated. On the other hand, if the amount of the ethylene-α-olefin copolymer rubber is less than 5 wt %, impact strength and dimensional stability may be deteriorated.

The magnesium compound is an acicular compound including 91 to 99 wt % of magnesium hydroxide sulfate trihydrate (MgSO₄.5Mg(OH)₂.3H₂O) and 1 to 9 wt % of magnesium hydroxide and added to the polypropylene resin composition to improve dimensional stability and rigidity. The magnesium compound used herein may have an average diameter in the range of 0.5 to 1.0 μm and an average length in the range of 8 to 30 μm. The amount of the magnesium compound may be in the range of 1 to 7 wt %, preferably 2 to 6 wt % based on the total weight of the polypropylene resin composition. In this regard, if the amount of the magnesium compound is less than 1 wt %, the effect of enhancing dimensional stability and rigidity may not be attained. On the other hand, if the amount of the magnesium compound is greater than 7 wt %, impact resistance may be deteriorated.

The inorganic filler may be formed of talc, barium sulfate, calcium carbonate, and wollastonite having an average particle size of 0.5 to 7 μm. Preferably, talc may be used to have excellent dispersibility and physical properties. The amount of the inorganic filler may be in the range of 15 to 30 wt %, preferably 15 to 25 wt % based on the total weight of the polypropylene resin composition. In this regard, if the amount of the inorganic filler is less than 15 wt %, rigidity and heat resistance may be deteriorated. On the other hand, if the amount of the inorganic filler is greater than 30 wt %, the effect of reducing the weight may not be attained, and impact strength may be deteriorated.

The polypropylene resin composition according to the present embodiment may further include additives.

Here, the additives may be any additives that are commonly used in the art, for example, an antioxidant, a neutralizing agent, and an antistatic agent, and the amount of the additives may be appropriately adjusted. The antioxidant may be a phenol-based antioxidant, a phosphite-based antioxidant, a thiodipropionate synergist, or the like. The neutralizing agent may be calcium stearate, zinc oxide, or the like. The polypropylene resin composition according to the present embodiment may have a melt index in the range of 15 to 30 g/10 min, preferably, 20 to 25 g/10 min. If the melt index of the polypropylene resin composition is less than 15 g/10 min, appearance problems such as weld line, sink, flow mark, etc., may be caused after molding. On the other hand, if the melt index of the polypropylene resin composition is greater than 30 g/10 min, rigidity and impact strength may be deteriorated.

The polypropylene resin composition according to the present embodiment may be prepared using any known applicable methods without limitation. For example, the polypropylene resin composition may be prepared by mixing the components described above by mechanical mixing that is commonly used in the art. Specifically, any melt-mixing device such as a Banbury mixer, a single screw extruder, a twin screw extruder, and a multi-screw extruder may be used. In addition, the mixing may be performed at a temperature from 170 to 240° C. The magnesium compound may be side-fed during extrusion molding to obtain intrinsic properties thereof.

The polypropylene resin composition according to the present embodiment may be molded using extrusion molding, blow molding, injection molding, sheet molding, or the like without limitation. Preferably, injection molding may be used.

Hereinafter, one or more embodiments will be described in detail with reference to the following examples. However, these examples are not intended to limit the purpose and scope of the invention.

### EXAMPLES

### Examples 1 to 4 and Comparative Examples 1 to 6

Polypropylene resin compositions having compositions as shown in Table 2 below were prepared using components as shown in Table 1 below.

TABLE 1
Components of polypropylene resin compositions and properties of each component

| | | Melt index | Ethylene |
|---|---|---|---|
| | | (g/10 min, | content |
| | | 230° C.) | (wt %) |
| Ethylene-propylene | PP-1 PP Block Copolymer | 30 | 7 |
| block copolymer | (Korea Petrochemical Ind. Co., | | |
| containing 3 to 20 | Ltd., CB5230) | | |
| wt % of ethylene | PP-2 PP Block Copolymer | 70 | 5 |
| | (PolyMirae Company Ltd., | | |
| | EP547U) | | |
| Ethylene-propylene | PP-3 PP Block Copolymer | 9 | 40 |
| block copolymer | (BASELL HIFAX CA207A) | | |
| containing 30 to 50 | | | |
| wt % of ethylene | | | |
| Ethylene-α-olefin | Ethylene/propylene copolymer | 50 wt % | |
| copolymer rubber | (EPR) | | |
| | Kumho KEP-020P | | |

| | Ethylene/butene-1 copolymer | | 20 wt % |
|---|---|---|---|
| | (EBM) | | |
| | MITSUI TAFMER DF605 | | |
| | Ethylene/octene-1 copolymer | | 30 wt % |
| | (EOM) | | |
| | DOW Engage8150 | | |
| Magnesium compound (UBE MOS-HIGH A) | | | 96 wt % of MgSO₄•5Mg(OH)₂•3H₂O + |
| | | | 4 wt % of Mg(OH)₂, average diameter: 0.8 μm, |
| | | | average length: 22 μm |
| Inorganic filler | T-1 Talc | Average | 2.9 μm |
| | (KOCH | particle size | |
| | KC2000) | | |
| | T-2 Talc | Average | 7.6 μm |
| | (KOCH | particle size | |
| | KC6300) | | |

The average particle size was measured using laser precipitation.

TABLE 2

| | | | Example | | | | Comparative Example | | | | | |
|---|---|---|---|---|---|---|---|---|---|---|---|---|
| | | | 1 | 2 | 3 | 4 | 1 | 2 | 3 | 4 | 5 | 6 |
| Composition | Ethylene-polypropylene | PP-1 | 35 | 35 | 35 | 37 | — | 40 | 29 | 35 | 35 | 35 |
| | block copolymer | PP-2 | 20 | 20 | 20 | 20 | — | 25 | 16 | 20 | 20 | 20 |
| | | PP-3 | 10 | 12 | 10 | 10 | 65 | — | 10 | 10 | 10 | 10 |
| | Ethylene-α-olefin | EPR | 3 | 3 | 0 | 3 | 3 | 3 | 5 | 3 | 3 | 3 |
| | copolymer rubber | EBR | 2 | 2 | 3 | 0 | 2 | 2 | 5 | 2 | 2 | 2 |
| | | EOR | 5 | 5 | 7 | 5 | 5 | 5 | 8 | 5 | 5 | 5 |
| | Magnesium compound | | 5 | 3 | 5 | 5 | 5 | 5 | 5 | — | 15 | 5 |
| | Inorganic filler | T-1 | 20 | 20 | 20 | 20 | 20 | 20 | 20 | 25 | 10 | — |
| | | T-2 | — | — | — | — | — | — | — | — | — | 20 |

Specifically, the components listed in Table 2 were mixed by dry blending using a Hensel mixer for 3 minutes and followed by injection molding the mixture using a twin screw extruder having a diameter of 32 mmφ at 200° C. to obtain the resin composition.

### Examples 1 to 4 and Comparative Examples 1 to 6

Physical properties of samples prepared according to Examples 1 to 4 and Comparative Examples 1 to 6 were evaluated according to the methods presented in Table 3 below, and the results are shown in Table 4 below.

TABLE 3

| Test items | Measurement or evaluation methods |
|---|---|
| Melt index (MI) | Measured according to ASTM D1238 at 230° C., |
| | under 2.16 kg. |
| Flexural modulus | Measured according to ASRM D790. |
| IZOD impact | Measured according to ASTM D256. (sample size: |
| (room | 63.5 × 12.7 × 6.4 mm, notched) |
| temperature) | |
| Weather | Measured using a WEATHER-O METER (Xenon arc |
| resistance | according to ISO 105, JIS L 0843, ASTM D6695, and |
| | SAE J 2527), having QUARTZ, as an internal filter, |
| | “TYPE S” BOROSILICATE, as an external filter, |
| | Continuously exposed at 2500 KJ/m² [340 nm], |
| | BLACK PANEL temperature: 70 ± 2° C. (LIGHT), |
| | 38 ± 2° C. (DARK), cycle: exposed for 40 minutes |
| | (50 ± 5% RH) |
| | Exposed for 20 minutes (surface SPRAY), exposed for |
| | 60 minutes (50 ± 5% RH), not exposed for 60 minutes |
| | (95 ± 5% RH, surface/backside surface SPRAY), |
| | illumination: 0.55 ± 0.2 W/(m² · nm) [340 nm] |
| | Evaluation standard: severe discoloration, fadedness, |
| | and CRAZING should not be observed. |
| | GRAY SCALE: 4-5, ΔE*: 3 or less |
| Coefficient | Measured according to ASTM E 831. |
| of linear | |
| expansion | |
| Appearance | Surface status of injection molded product was |
| of product | evaluated according to Table 4 below. |

TABLE 4

| | Evaluation standard | |
|---|---|---|
| Grade | Appearance | Result |
| □ | Surface was in good condition. | Pass |
| ◯ | Slight weld line, sink, or flow mark are observed. | |
| □ | Distinct weld line, sink, or flow mark are observed. | Fail |
| X | Severe weld line, sink, or flow mark are observed. | |

TABLE 5

| | Example | | | | Comparative Example | | | | | |
|---|---|---|---|---|---|---|---|---|---|---|
| | 1 | 2 | 3 | 4 | 1 | 2 | 3 | 4 | 5 | 6 |
| Melt index | 23 | 24 | 25 | 24 | 6 | 28 | 20 | 22 | 18 | 22 |
| (MI) | | | | | | | | | | |
| Flexural | 22000 | 21000 | 21500 | 22500 | 17000 | 27000 | 15000 | 18000 | 34000 | 20000 |
| modulus | | | | | | | | | | |
| IZOD | 26 | 27 | 29 | 25 | 32 | 21 | 35 | 28 | 19 | 20 |
| impact | | | | | | | | | | |
| Weather | good | good | good | good | good | good | good | good | good | good |
| resistance | | | | | | | | | | |
| Coefficient | 5.5 × 10⁻⁵ | 5.7 × 10⁻⁵ | 5.6 × 10⁻⁵ | 5.6 × 10⁻⁵ | 5.7 × 10⁻⁵ | 9.3 × 10⁻⁵ | 5.1 × 10⁻⁵ | 9.8 × 10⁻⁵ | 4.1 × 10⁻⁵ | 6.5 × 10⁻⁵ |
| of linear | | | | | | | | | | |
| expansion | | | | | | | | | | |
| Appearance | □ | □ | □ | □ | X | □ | □ | □ | □ | □ |

Referring to the results of Table 5, it was identified that the polypropylene resin compositions prepared according to Examples 1 to 4 have excellent dimensional stability, flexural modulus, impact resistance, and good appearance of the product.

On the other hand, if the ethylene-propylene block copolymer containing 3 to 20 wt % of an ethylene monomer is not used, as in Comparative Example 1, the fluidity of the resin may be deteriorated to cause weld line, sink, or flow mark on the surface of the product, and thus the product may not be suitable for commercialization. In addition, if the ethylene-propylene block copolymer containing 30 to 50 wt % of an ethylene monomer is not used, as in Comparative Example 2, the coefficient of linear expansion may increase, and thus dimensional stability may be poor. If the content of the ethylene-α-olefin copolymer rubber is excessive, as in Comparative Example 3, rigidity may be deteriorated, so that the product may not be easily molded, or the molded product may be easily deformed. If the magnesium compound is not used, as in Comparative Example 4, flexural modulus and dimensional stability may be deteriorated, and the molded product may be deformed. In addition, if the content of the magnesium compound is excessive or if the inorganic filler having a large particle size is used, as in Comparative Examples 5 and 6, impact strength may be deteriorated, so that products may easily break by external impact.

As described above, the polypropylene resin composition according to the present invention provides superior dimensional stability, balance between impact resistance and rigidity, weather resistance, fluidity, appearance quality, and molding efficiency. Thus, the polypropylene resin composition may be efficiently applied to a cowl top cover for an automobile.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A polypropylene resin composition comprising:
30 to 70 wt % of an ethylene-propylene block copolymer comprising 3 to 20 wt % of an ethylene monomer;
5 to 20 wt % of an ethylene-propylene block copolymer comprising 30 to 50 wt % of an ethylene monomer;
5 to 15 wt % of an ethylene-α-olefin copolymer rubber;
1 to 7 wt % of a magnesium compound; and
15 to 30 wt % of an inorganic filler.

2. The polypropylene resin composition of claim 1, wherein the ethylene-propylene block copolymer comprising 3 to 20 wt % of an ethylene monomer has a melt index in the range of 10 to 80 g/10 min at 230° C.

3. The polypropylene resin composition of claim 1, wherein the ethylene-propylene block copolymer comprising 30 to 50 wt % of an ethylene monomer has a melt index in the range of 3 to 15 g/10 min at 230° C.

4. The polypropylene resin composition of claim 1, wherein the magnesium compound comprises 91 to 99 wt % of magnesium hydroxide sulfate trihydrate (MgSO₄.5Mg(OH)₂.3H₂O) and 1 to 9 wt % of magnesium hydroxide and is an acicular compound having an average diameter in the range of 0.5 to 1.0 μm and an average length in the range of 8 to 30 μm.
